(19) United States
(12) Patent Application Publication
(10) Pub. No.: US 2026/0168532 A1
(43) Pub. Date: Jun. 18, 2026

(54) RADIAL THRUST BEARING

(71) Applicant: NIPPON THOMPSON CO., LTD., Tokyo (JP)

(72) Inventor: Satoshi SASAKI, Mino-shi (JP)

(73) Assignee: NIPPON THOMPSON CO., LTD., Tokyo (JP)

(21) Appl. No.: 19/128,640

(22) PCT Filed: Aug. 21, 2023
(86) PCT No.: PCT/JP2023/030013

§ 371 Date: May 9, 2025

(30) Foreign Application Priority Data
Nov. 14, 2022 (JP) 2022-181893

(51) Int. Cl. F16C 19/38; F16C 33/66; F16C 37/00

(52) U.S. Cl. CPC F16C 19/381; F16C 33/6681; F16C 37/007

(57) ABSTRACT

A radial thrust bearing includes radial rolling elements, a radial cage, thrust rolling elements, a thrust cage, an outer ring, and an inner ring. The outer ring has a through hole that reaches a raceway region of the radial rolling elements from outside. The radial cage includes a pair of annular portions disposed at an interval in an axial direction, and pillar portions coupled to the pair of annular portions and disposed at an interval in a circumferential direction to form pockets that house the radial rolling elements. Radially outer surfaces of the pillar portions include grooves each extending in the axial direction and recessed radially inward. Each of the grooves has an opening at least one axial end of a corresponding one of the pillar portions.

### TECHNICAL FIELD

The present disclosure relates to a radial thrust bearing. This application claims priority to Japanese Patent Application No. 2022-181893, which was filed on Nov. 14, 2022, and is incorporated herein by reference in its entirety.

### BACKGROUND ART

A thrust needle roller bearing including a cage for holding needle rollers has been known (see, for example, Patent Literature 1). The cage included in the thrust needle roller bearing disclosed in Patent Literature 1 has a projection or a recess that inhibits a flow of lubricating oil on an axial side surface of a pillar part located between pockets. A cage for use in a double-row roller bearing is also known (see, for example, Patent Literature 2). The cage disclosed in Patent Literature 2 includes a single annular part, multiple pillar parts extending from one side face of the annular part to one side in the axial direction, and multiple pillar parts extending from the other side face of the annular part to the other side in the axial direction.

### CITATION LIST

### Patent Literatures

Patent Literature 1: Japanese Patent Application Publication No. 2016-1026

Patent Literature 2: Japanese Patent Application Publication No. 2019-65919

### SUMMARY OF INVENTION

### Technical Problem

In recent years, in a situation where it is necessary to receive a load in a radial direction and a load in a thrust direction, a radial thrust bearing capable of receiving both the loads is used. Such a radial thrust bearing is suitably used because, for example, the bearing can be easily miniaturized as compared to the case of using a radial roller bearing and a thrust roller bearing. Here, in a situation where a heat source such as a motor is close to the bearing or the bearing is rotated at high speed so that the bearing is thereby heated to a high temperature, a radial thrust bearing is employed in some cases. In such cases, it is required to smoothly rotate rolling elements while efficiently cooling the radial thrust bearing.

It is therefore an object of the present disclosure to provide a radial thrust bearing enabling efficient cooling and smooth rolling of rolling elements.

### Solution to Problems

A radial thrust bearing according to the present disclosure receives a load in a radial direction and a load in a thrust direction. A radial thrust bearing includes: a plurality of radial rolling elements that are subjected to the load in the radial direction; a radial cage that holds the plurality of radial rolling elements; a plurality of thrust rolling elements that are subjected to the load in the thrust direction; a thrust cage that holds the plurality of thrust rolling elements; an outer ring including a first outer ring raceway surface that contacts rolling surfaces of the radial rolling elements; and an inner ring including a first inner ring raceway surface that contacts the rolling surfaces of the radial rolling elements The outer ring includes a second outer ring raceway surface that contacts rolling surfaces of the thrust rolling elements. The inner ring includes a second inner ring raceway surface that contacts rolling surfaces of the thrust rolling elements. The outer ring has a through hole that reaches a raceway region of the radial rolling elements from outside. The radial cage includes a pair of annular portions disposed at an interval in an axial direction, and pillar portions coupled to the pair of annular portions and disposed at an interval in a circumferential direction to form pockets that house the radial rolling elements. Radially outer surfaces of the pillar portions include grooves extending in the axial direction and recessed radially inward. Each of the grooves has an opening at least one axial end of a corresponding one of the pillar portions.

### Solution to Problems

The radial thrust bearing ensures effective cooling and smooth rolling of rolling elements.

### BRIEF DESCRIPTION OF DRAWINGS

FIG. 1 is a schematic perspective view illustrating an appearance of a radial thrust bearing according to a first embodiment of the present disclosure.

FIG. 2 is a schematic plan view of the radial thrust bearing shown in FIG. 1 as seen in an axial direction.

FIG. 3 is a schematic side view of the radial thrust bearing shown in FIG. 1 as seen from a radially outer side.

FIG. 4 is a schematic cross-sectional view partially illustrating the radial thrust bearing shown in FIG. 1.

FIG. 5 is a disassembled view of the radial thrust bearing shown in FIG. 1.

FIG. 6 is an enlarged view partially illustrating the radial thrust bearing shown in FIG. 1.

FIG. 7 is a view illustrating a state where an outer ring described later is detached in the radial thrust bearing shown in FIG. 6.

FIG. 8 is an external perspective view of a radial cage.

FIG. 9 is an enlarged view of a region indicated by IX in the radial cage shown in FIG. 8.

FIG. 10 is an enlarged view of a portion of the radial thrust bearing from which the outer ring is detached, as seen in a radial direction.

FIG. 11 is an enlarged cross-sectional view partially illustrating the radial cage.

FIG. 12 is a view of a portion of the radial cage, as seen from a radially outer side.

### DESCRIPTION OF EMBODIMENTS

### Summary of Embodiment

A radial thrust bearing according to the present disclosure receives a load in a radial direction and a load in a thrust direction. The radial thrust bearing includes: a plurality of radial rolling elements that are subjected to the load in the radial direction; a radial cage that holds the plurality of radial rolling elements; a plurality of thrust rolling elements that are subjected to the load in the thrust direction; a thrust cage that holds the plurality of thrust rolling elements; an outer ring including a first outer ring raceway surface that contacts rolling surfaces of the radial rolling elements; and an inner ring including a first inner ring raceway surface that contacts the rolling surfaces of the radial rolling elements. The outer ring includes a second outer ring raceway surface that contacts rolling surfaces of the thrust rolling elements. The inner ring includes a second inner ring raceway surface that contacts rolling surfaces of the thrust rolling elements. The outer ring has a through hole that reaches a raceway region of the radial rolling elements from outside. The radial cage includes a pair of annular portions disposed at an interval in an axial direction, and pillar portions coupled to the pair of annular portions and disposed at an interval in a circumferential direction to form pockets that house the radial rolling elements. Radially outer surfaces of the pillar portions include grooves extending in the axial direction and recessed radially inward. Each of the grooves has an opening at least one axial end of a corresponding one of the pillar portions.

Since the radial thrust bearing according to the present disclosure includes the plurality of radial rolling elements that are subjected to the load in the radial direction and the plurality of thrust rolling elements that are subjected to the load in the thrust direction, the load in the radial direction and the load in the thrust direction can be appropriately received by one bearing. Consequently, the bearing can be miniaturized. In addition, since the bearing includes the radial cage that holds the radial rolling elements and the thrust cage that holds the thrust rolling elements, postures of these rolling elements can be stabilized.

In a case where the radial thrust bearing is used near a heat source or is rotated at high speed, the radial thrust bearing itself might be heated to a high temperature. In such cases, to stably roll the radial rolling elements and the thrust rolling elements, the bearing needs to be cooled. The outer ring included in the radial thrust bearing of the present disclosure has the through hole that reaches the raceway region of the plurality of radial rolling elements from outside, and thus, a lubricant with flowability, such as oil air or oil mist, can be supplied to the inside of the bearing by using the through hole. Accordingly, cooling of inside of the bearing and enhancement of lubricating performance can be achieved. Here, radially outer surfaces of the pillar portions of the radial cage have grooves each of which has an opening at least one axial end of a corresponding one of the pillar portions. Each groove extends in the axial direction and is recessed radially inward. Accordingly, the lubricant that has reached the radially outer surface of the radial cage through the through hole can be supplied toward the opening side in the axial direction by using the grooves. The thus-configured radial bearing can efficiently cool the inside of the bearing by supplying the lubricant using the grooves to thereby enhance lubricating performance of the supplied lubricant to the radial rolling elements and the thrust rolling elements. In the manner described above, the radial thrust bearing ensures effective cooling and smooth rolling of the rolling elements.

In the axial thrust bearing, a wall surface constituting each of the grooves may include an arc-shaped curve, as seen in the axial direction. With this configuration, the lubricant supplied through the through hole is smoothly discharged from the grooves in the axial direction, and thus, it is possible to reduce the possibility that the lubricant remains in the grooves. As a result, more efficient cooling and more smooth rolling of the rolling elements can be obtained.

In the radial thrust bearing, each of the grooves has an opening only at one axial end of a corresponding one of the pillar portions. With this configuration, in a case where a heat source is located on one side in the axial direction, the openings of the grooves are located on the side of the heat source so that the lubricant can be thereby positively supplied toward the heat source. As a result, more efficient cooling can be obtained.

In the radial thrust bearing, a wall surface constituting each of the grooves at another axial end may include a portion of a spherical surface. With this configuration, it is possible to reduce the possibility that the lubricant remains in the grooves on the closed side of the grooves. As a result, more efficient cooling and more smooth rolling of the rolling elements can be obtained.

In the radial thrust bearing, each of the pillar portions may include projecting regions projecting toward the pockets, on a radially outer side and a radially inner side of the pair of annular portions. With this configuration, the projecting regions can prevent the rolling elements housed in the pockets from falling off.

In the radial thrust bearing, the through hole may include a plurality of through holes arranged at intervals in the circumferential direction and having openings at a radially outer surface of the outer ring. With this configuration, the lubricant is supplied from the through holes and discharged from the through holes. As a result, more efficient cooling can be performed.

In the radial thrust bearing, each of the wall surfaces constituting the through holes may be oriented straight in a radial direction. This configuration can reduce resistance in supplying the lubricant into the bearing. Accordingly, the lubricant can be smoothly supplied from the outside to the raceway region of the radial rolling elements.

In the radial thrust bearing, each of the wall surfaces constituting the through holes may be tapered such that the wall surface is gradually enlarged toward the radially outer surface. With this configuration, the lubricant can be forcefully supplied into the grooves so that supply of the lubricant into the bearing can be quickly performed.

In the radial thrust bearing, the plurality of thrust rolling elements may be arranged in double rows at both axial ends of the radial rolling elements in the axial direction. The thrust cage may include a pair of thrust cages that holds the plurality of thrust rolling elements arranged in the double rows. With this configuration, a larger thrust load can be received by the plurality of thrust rolling elements arranged in the double rows. This increases a withstand load in the thrust direction.

### Specific Examples of Embodiments

Next, an example of specific embodiments of a radial thrust bearing according to the present disclosure will be described with reference to the drawings. In the following drawings, the same or corresponding parts are denoted by the same reference numerals, and the description thereof will not be repeated.

### First Embodiment

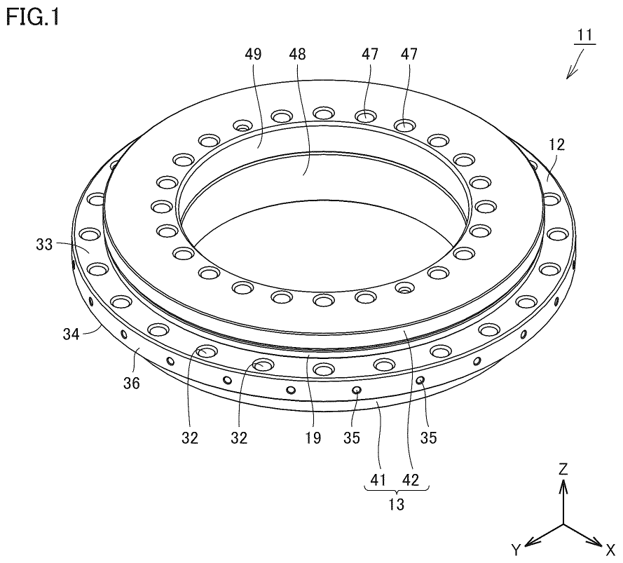

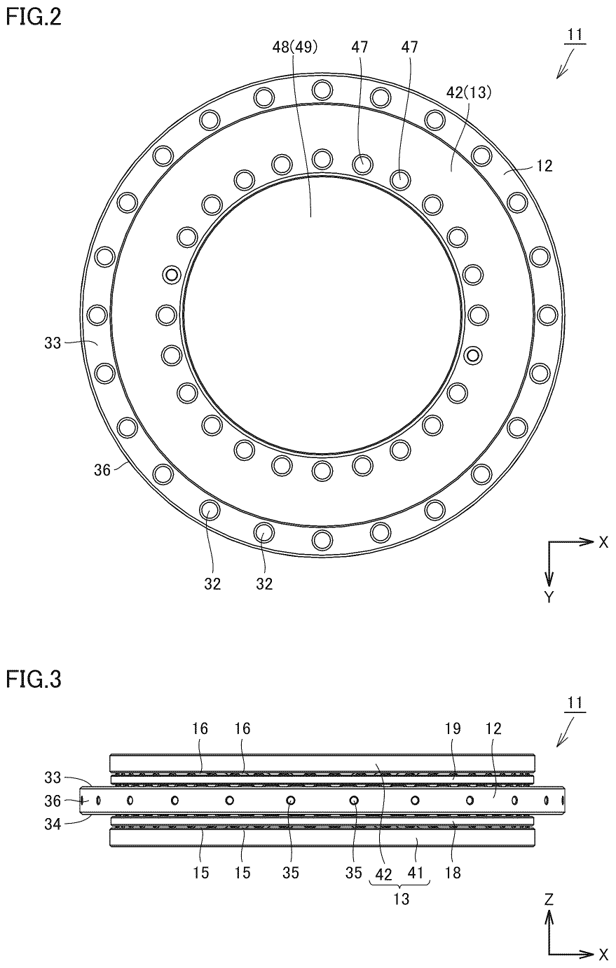

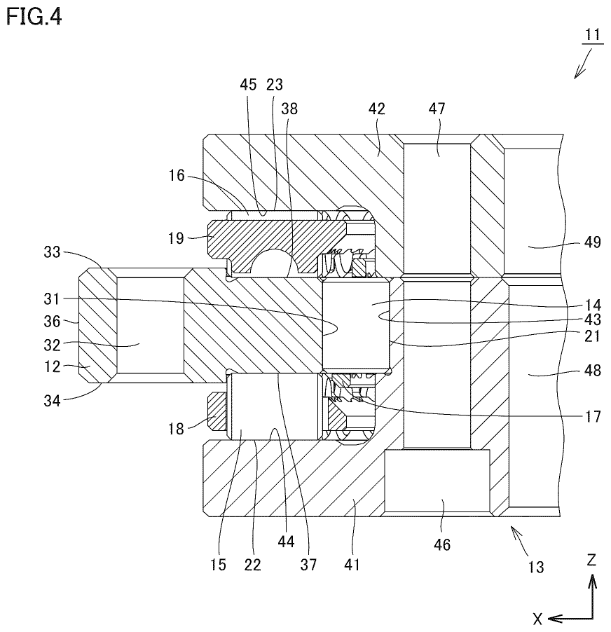

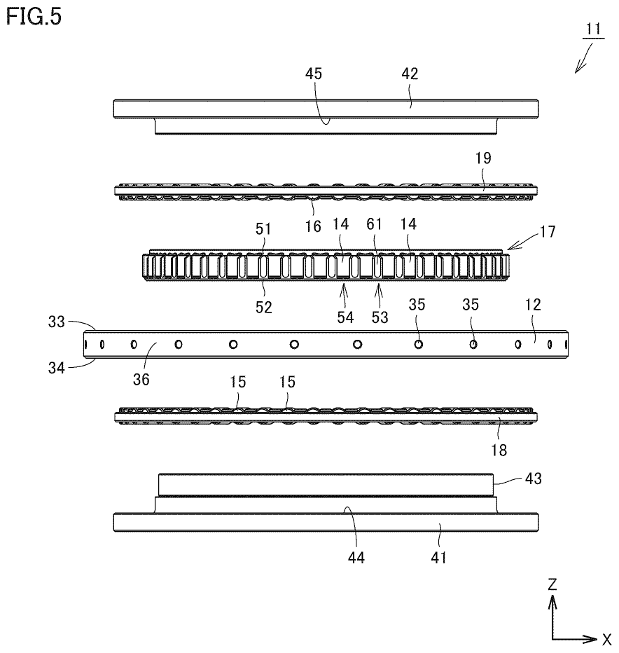

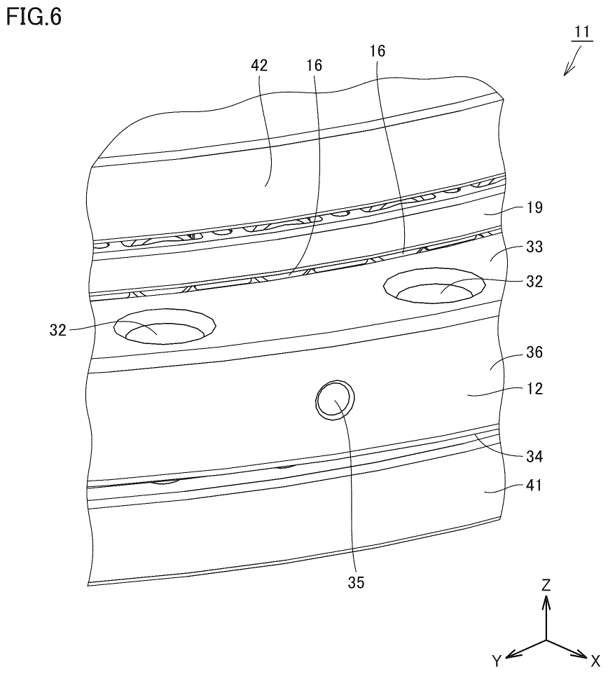

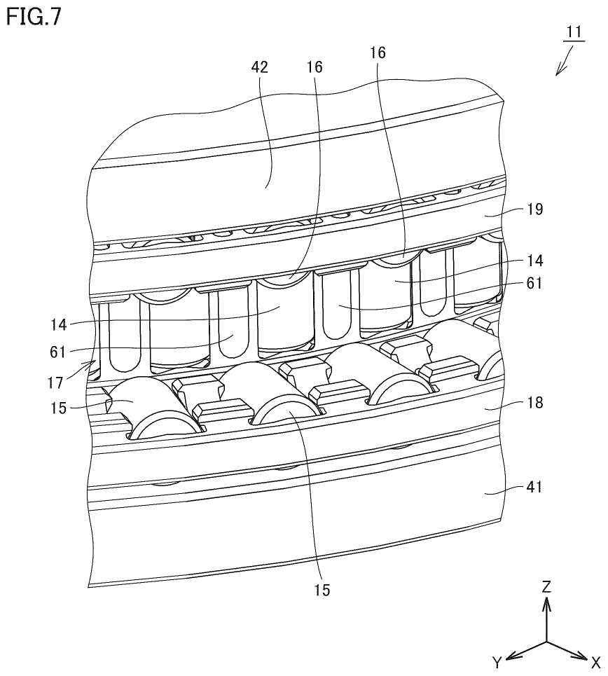

First, a first embodiment, which is an embodiment of the present disclosure, will be described. FIG. 1 is a schematic perspective view illustrating an appearance of a radial thrust bearing according to a first embodiment of the present disclosure. FIG. 2 is a schematic plan view of the radial thrust bearing shown in FIG. 1 as seen in an axial direction. FIG. 2 is a view seen from a direction opposite to the direction of arrow Z shown in FIG. 1. In FIG. 1 and the following drawings, a Z direction indicates an axial direction. That is, although not shown, a shaft supported by the radial thrust bearing extends in the Z direction. An X direction and a Y direction indicate radial directions from the center of the radial thrust bearing as seen in an axial direction. The X direction is a direction orthogonal to the Y direction in a plane perpendicular to the axial direction. FIG. 3 is a schematic side view of the radial thrust bearing shown in FIG. 1 as seen from a radially outer side. FIG. 4 is a schematic cross-sectional view partially illustrating the radial thrust bearing shown in FIG. 1. FIG. 4 is a cross-sectional view in a case where the bearing is cut along an X-Z plane. FIG. 5 is a disassembled view of the radial thrust bearing shown in FIG. 1. FIG. 6 is an enlarged view partially illustrating the radial thrust bearing shown in FIG. 1. FIG. 7 is a view illustrating a state where an outer ring described later is detached in the radial thrust bearing shown in FIG. 6.

With reference to FIGS. 1 through 7, a radial thrust bearing 11 according to a first embodiment of the present disclosure is a bearing capable of receiving a load in a radial direction and a load in a thrust direction. A radial thrust bearing 11 includes: an outer ring 12; an inner ring 13; a plurality of radial rollers 14 as a plurality of radial rolling elements that are subjected to a load in a radial direction; a plurality of thrust rollers 15 as a plurality of thrust rolling elements to which a load in a thrust direction is applied; a plurality of thrust rollers 16 as a plurality of thrust rolling elements to which a load in a thrust direction is applied; a radial cage 17 that holds the plurality of radial rollers 14; a thrust cage 18 that holds the plurality of thrust rollers 15; and a thrust cage 19 that holds the plurality of thrust rollers 16. All the radial rollers 14, the thrust rollers 15, and the thrust rollers 16 may have the same shape. That is, rollers are classified into the radial rollers 14, the thrust rollers 15, and the thrust rollers 16, depending on positions where the rollers are arranged.

The plurality of thrust rollers 15 are arranged in double rows at an interval in the axial direction, and the plurality of thrust rollers 16 are arranged in double rows at an interval in the axial direction. In this embodiment, the plurality of thrust rollers 15 are arranged in double rows and the plurality of thrust rollers 16 are arranged in double rows in the axial direction, at both axial ends of the radial rollers 14. The thrust cage 18 and the thrust cage 19 are provided as a pair to respectively hold the thrust rollers 15 arranged in the double rows and the thrust rollers 16 arranged in the double rows. The thus-configured radial thrust bearing 11 can receive a larger thrust load with the plurality of thrust rollers 15 in the double rows and the plurality of thrust rollers 16 in the double rows. This increases a withstand load in the thrust direction. The radial thrust bearing 11 is suitably used as a slewing bearing.

The outer ring 12 has a disc shape having a hole penetrating the outer ring 12 in the axial direction at the center in the radial direction. A radially inner surface of the outer ring 12 serves as a first outer ring raceway surface 31 that contacts rolling surfaces 21 of the radial rollers 14. That is, the outer ring 12 includes the first outer ring raceway surface 31 that contacts the rolling surfaces 21 of the radial rollers 14. The outer ring 12 has a plurality of attachment holes 32 penetrating the outer ring 12 in the axial direction and arranged at intervals in the circumferential direction. That is, the attachment holes 32 each extend from one axial end surface 33 of the outer ring 12 to the other axial end surface 24 of the outer ring 12. These attachment holes 32 are round holes and used for, for example, attaching the outer ring 12 to other members.

The outer ring 12 has through holes 35 that reach a raceway region of the plurality of radial rollers 14 from the outside. The through holes 35 are arranged at intervals in the circumferential direction. The through holes 35 are also called grease supply holes and are open at a radially outer surface 36 of the outer ring 12. The through holes 35 penetrate the outer ring 12 in the radial direction. Wall surfaces constituting the through holes 35 are oriented straight in the radial direction. The plurality of through holes 35 are displaced from the attachment holes 32 in the circumferential direction. That is, as seen in the axial direction, the positions of the attachment holes 32 are displaced from the positions of the through holes 35 in the circumferential direction. The through holes 35 are also round holes. The diameter of each through hole 35 is smaller than the diameter of each attachment hole 32. These through holes 35 are used for supplying or discharging a lubricant such as oil air or oil mist into the bearing or to the outside of the bearing in order to cool the radial thrust bearing 11 and providing lubricity. Among the plurality of through holes 35, a ratio of the through holes 35 used for supplying oil air to the through holes 35 used for discharging oil air is arbitrarily adjusted in accordance with cooling performance, lubricating performance, the amount of heat generated from the heat source, and others.

The outer ring 12 includes a second outer ring raceway surface 37 that contacts rolling surfaces 22 of the thrust rollers 15. The outer ring 12 includes a second outer ring raceway surface 38 that contacts rolling surfaces 23 of the thrust rollers 16. The second outer ring raceway surface 37 and the second outer ring raceway surface 38 are disposed at an interval in the axial direction.

The inner ring 13 is constituted by a combination of two races 41 and 42. Both the first race 41 and the second race 42 have disc shapes having holes 48 and 49, respectively, penetrating the first race 41 and the second race 42 in the axial direction at the center in the radial direction. The first race 41 and the second race 42 are combined such that the first race 41 and the second race 42 are in contact with each other in the axial direction. The radial thrust bearing 11 supports a shaft (not shown) placed in the hole 48 and the hole 49 located radially inward of the inner ring 13. A portion of the radially outer surface of the first race 41 serves as a first inner ring raceway surface 43 that contacts the rolling surfaces 21 of the radial rollers 14. That is, the inner ring 13 includes the first inner ring raceway surface 43 that contacts the rolling surfaces 21 of the radial rollers 14. A space between the first outer ring raceway surface 31 and the first inner ring raceway surface 43 in the radial direction is a raceway region in which the plurality of radial rollers 14 roll.

The first race 41 includes a second inner ring raceway surface 44 that contacts the rolling surfaces 22 of the thrust rollers 15. The second race 42 includes a second inner ring raceway surface 45 that contacts the rolling surfaces 23 of the thrust rollers 16. The second inner ring raceway surface 44 and the second inner ring raceway surface 45 face each other in the axial direction. A space between the second outer ring raceway surface 37 and the second inner ring raceway surface 44 in the axial direction is a raceway region in which the plurality of thrust rollers 15 roll. A space between the second outer ring raceway surface 38 and the second inner ring raceway surface 45 in the axial direction is a raceway region in which the plurality of thrust rollers 16 roll.

The first race 41 has coupling holes 46 penetrating the first race 41 in the axial direction. The coupling holes 46 are arranged at intervals in the circumferential direction. The coupling holes 46 are located radially inward of the second inner ring raceway surface 44. The second race 42 has coupling holes 47 penetrating the second race 42 in the axial direction. The coupling holes 47 are arranged at intervals in the circumferential direction. The coupling holes 47 are located radially inward of the second inner ring raceway surface 45. The interval of the coupling holes 47 in the circumferential direction is equal to the interval of the coupling holes 46 in the circumferential direction. By using the coupling holes 46 and the coupling holes 47, the first race 41 and the second race 42 are coupled with bolts.

The thrust cage 18 holding the plurality of thrust rollers 15 is located between the second outer ring raceway surface 37 and the second inner ring raceway surface 44. The thrust cage 18 has a disc shape, and pockets holding the plurality of thrust rollers 15 are arranged at intervals in the circumferential direction. The thrust cage 19 holding the plurality of thrust rollers 16 is located between the second outer ring raceway surface 38 and the second inner ring raceway surface 45. The thrust cage 19 has a disc shape, and pockets holding the plurality of thrust rollers 16 are arranged at intervals in the circumferential direction.

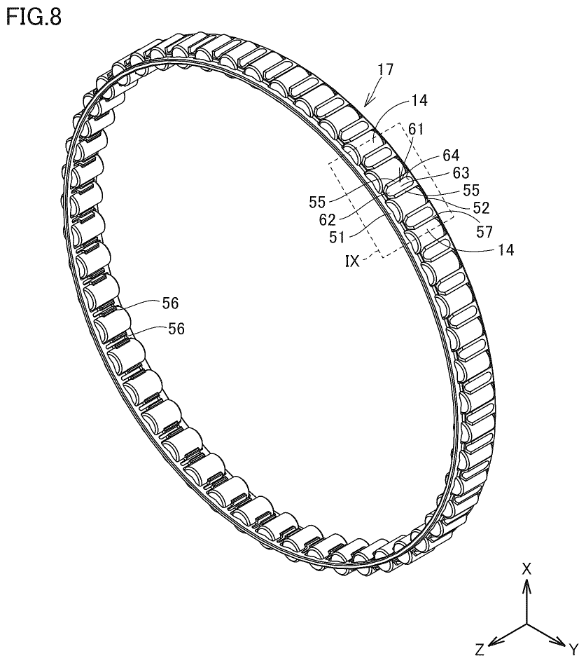

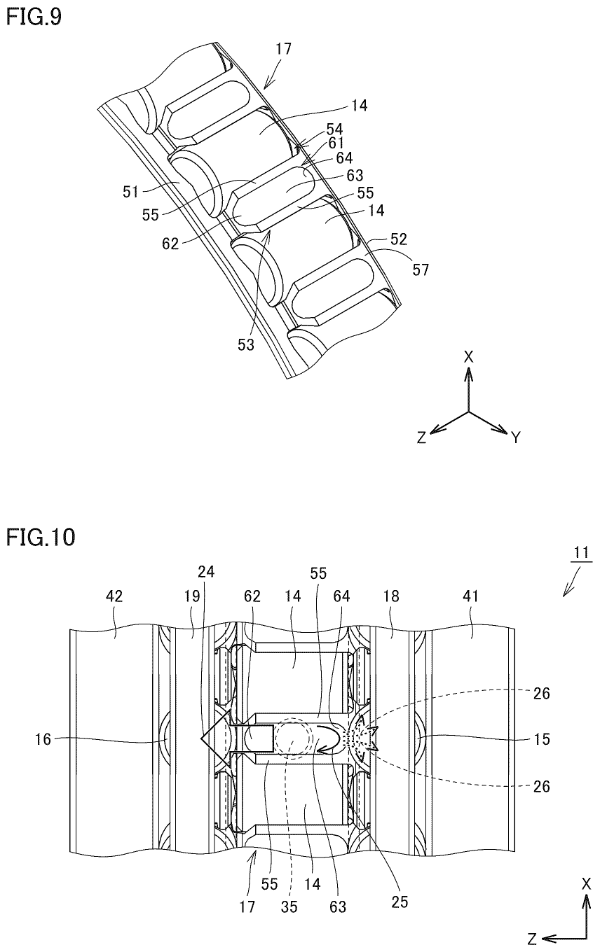

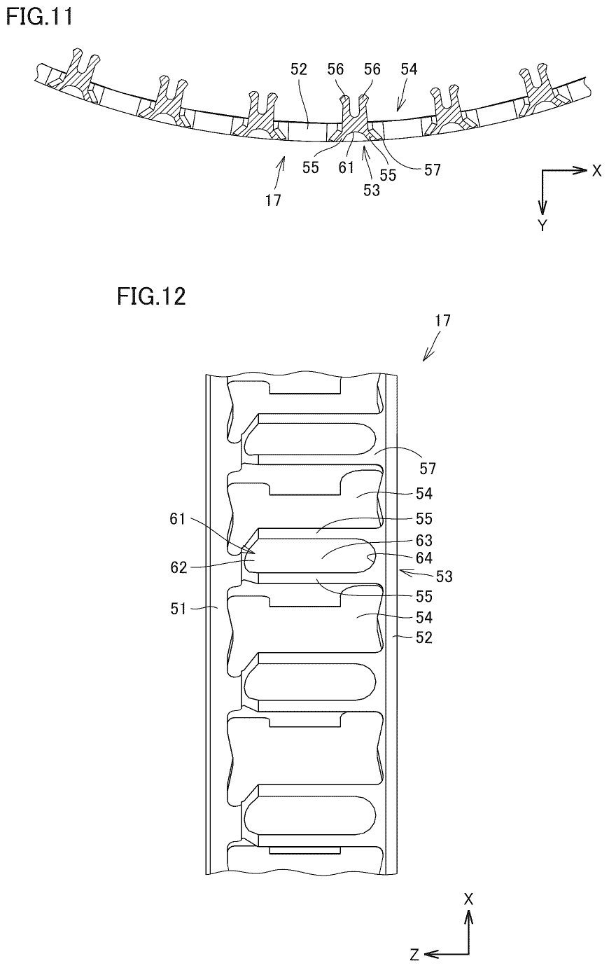

Next, a configuration of the radial cage 17 will be described. FIG. 8 is an external perspective view of the radial cage 17. FIG. 8 also shows the radial rollers 14. FIG. 9 is an enlarged view of a region indicated by IX in the radial cage 17 shown in FIG. 8. FIG. 10 is an enlarged view of a portion of the radial thrust bearing 11 from which the outer ring is detached, as seen in a radial direction. FIG. 11 is an enlarged cross-sectional view partially illustrating the radial cage 17. FIG. 11 is a schematic cross-sectional view taken in a X-Y plane. FIG. 12 is a view of a portion of the radial cage 17, as seen from a radially outer side.

With reference to FIGS. 8 through 12, the radial cage 17 holds the plurality of radial rollers 14. The radial cage 17 includes an annular portion 51 and an annular portion 52 that are disposed at an interval in the axial direction, and also includes a plurality of pillar portions 53. The annular portion 51 and the annular portion 52 are provided as a pair. Each of the plurality of pillar portions 53 has a shape extending in the axial direction, and is coupled to the pair of the annular portion 51 and the annular portion 52. The plurality of pillar portions 53 are arranged at intervals in the circumferential direction to form pockets 54 that house the radial rollers 14. Each of the pockets 54 houses a corresponding one of the radial rollers 14. The pillar portions 53 include a projecting region 55 and a projecting region 56 that project toward the pockets 54 on the radially outer side and the radially inner side of the pair of the annular portion 51 and the annular portion 52. The projecting region 55 and the projecting region 56 can prevent the radial rollers 14 housed in the pockets 54 from falling off. Housing of the radial rollers 14 in the pockets 54 is carried out by elastically deforming any of the projecting region 55 and the projecting region 56 and pushing the projecting region 55 and the projecting region 56 into the pockets 54 in the radial direction.

Here, radially outer surfaces 57 of the pillar portions 53 have grooves 61 extending in the axial direction and recessed radially inward. The grooves 61 are individually formed on the pillar portions 53. Each of the grooves 61 has an opening 62 at least one axial end of a corresponding one of the pillar portions 53. In this embodiment, each of the grooves 61 has the opening 62 only at one axial end of a corresponding one of the pillar portion 53. A wall surface 63 constituting each groove 61 includes an arc-shaped curve as seen in the axial direction. In this embodiment, the wall surface 63 constituting each groove 61 is a semicircular curve as seen in the axial direction A wall surface 64 constituting each groove 61 at the other axial end includes a portion of a spherical surface. In this embodiment, the wall surface 64 constituting the groove 61 at the other axial end is a portion of a spherical surface. The width of the grooves 61 in the circumferential direction, the depth of the grooves 61 in the radial direction, the positions of the closed grooves 61, and others are arbitrarily set.

Since the thus-configured radial thrust bearing 11 includes the plurality of radial rollers 14 that receive a load in the radial direction and the plurality of thrust rollers 15 and the plurality of thrust rollers 16 that are subjected to a load in the thrust direction, the load in the radial direction and the load in the thrust direction can be appropriately received by one bearing. g. Consequently, the bearing can be miniaturized. In addition, since the bearing includes the radial cage 17 holding the radial rollers 14, the thrust cage 18 holding the thrust rollers 15, and the thrust cage 19 holding the thrust rollers 16, postures of the rollers can be stabilized during rolling.

In a case where the radial thrust bearing 11 is used near a heat source or is rotated at high speed, the radial thrust bearing 11 itself might be heated to a high temperature. In such cases, to stably roll the radial rollers 14, the thrust rollers 15, and the thrust rollers 16, the bearing needs to be cooled. The outer ring 12 included in the radial thrust bearing 11 of the present disclosure has the through holes 35 that reach the raceway region of the plurality of radial rollers 14 from the outside, and thus, a lubricant with flowability, such as oil air or oil mist, can be supplied to the inside of the bearing by using the through holes 35. Accordingly, cooling of inside of the bearing and enhancement of lubricating performance can be achieved. Radially outer surfaces 57 of the pillar portions 53 of the radial cage 17 have grooves 61 with openings 62 at one axial ends of the pillar portions 53. Each of the grooves 61 extends in the axial direction and is recessed radially inward. Accordingly, the lubricant that has reached the radially outer surfaces 57 of the radial cage 17 through the through holes 35 can be supplied toward the openings 62 in the axial direction by using the grooves 61. In this embodiment, referring particularly to FIG. 10, the lubricant can be positively supplied toward the second race 42, as indicated by arrow 24. On the closed side, that is, on the side of the first race 41, the lubricant remains as indicated by arrow 25, and is gradually supplied radially outward as indicated by broken arrows 26. The thus-configured radial thrust bearing 11 can efficiently cool the inside of the bearing by supplying the lubricant using the grooves 61 to thereby enhance lubricating performance of the supplied lubricant to the radial rollers 14, the thrust rollers 15, and the thrust rollers 16. In the manner described above, the radial thrust bearing 11 can achieve efficient cooling and smooth rolling of the rollers.

In this embodiment, each of the wall surfaces 63 constituting the grooves 61 has an arc-shaped curve as seen in the axial direction. Accordingly, the lubricant supplied through the through holes 35 is smoothly discharged from the grooves 61 in the axial direction, and thus, it is possible to reduce the possibility that the lubricant remains in the grooves 61. As a result, more efficient cooling and more smooth rolling of the rollers can be obtained.

In this embodiment, each of the grooves 61 has the opening 62 only at one axial end of a corresponding one of the pillar portions 53. Thus, in a case where the heat source is located on one side in the axial direction, the openings 62 of the grooves 61 are located on the side of the heat source so that the lubricant can be thereby positively supplied to the heat source. As a result, more efficient cooling can be obtained.

In this embodiment, each of the wall surfaces 64 constituting the grooves 61 at the other axial end includes a portion of a spherical surface. Thus, it is possible to reduce the possibility that the lubricant remains in the grooves 61 on the closed side of the grooves 61 As a result, more efficient cooling and more smooth rolling of the rollers can be obtained.

In this embodiment, the wall surfaces constituting the through holes 35 are oriented straight in the radial direction. This can reduce resistance in supplying the lubricant into the bearing. Accordingly, the lubricant can be smoothly supplied from the outside to the raceway region of the radial rollers 14.

### Other Embodiments

In the embodiment described above, each groove may have openings on both axial ends of the corresponding pillar portion. This allows the lubricant to be supplied to both axial ends of the pillar portion. Accordingly, the lubricant can be easily supplied into the entire bearing to enhance cooling and lubricating performance. This configuration is suitable for a case where the heat source is not located only on one side in the axial direction.

In the embodiment described above, the wall surfaces constituting the through holes are oriented straight in the radial direction, but the present disclosure is not limited to this configuration. For example, each of the wall surfaces constituting the through holes may be tapered such that the wall surface is gradually enlarged toward the radially outer surface. Accordingly, the lubricant can be forcefully supplied into the grooves so that supply of the lubricant into the bearing can be quickly performed.

In the embodiment described above, the plurality of thrust rollers are arranged in double rows, but the present disclosure is not limited to this configuration, and the thrust rollers may be arranged in a single row.

In the embodiment described above, rollers are used as rolling elements, but the present disclosure is not limited to this configuration, and balls may be used as rolling elements.

It should be understood that the embodiments disclosed here are illustrative and non-restrictive in every respect. The scope of the present invention is defined by the claims and is intended to include any modifications within the scope and meaning equivalent to the claims.

### DESCRIPTION OF REFERENCE NUMERALS

11 radial thrust bearing, 12 outer ring, 13 inner ring, 14 radial roller, 15, 16 thrust roller, 17 radial cage, 18, 19 thrust cage, 21, 22, 23 rolling surface, 24, 25, 26 arrow, 31 first outer ring raceway surface, 32 attachment hole, 33, 34 end surface, 35 through hole, 36, 57 radially outer surface, 37,38 second outer ring raceway surface, 41 race (first race), 42 race (second race), 43 first inner ring raceway surface, 44, 45 second inner ring raceway surface, 46, 47 coupling hole, 48, 49 hole, 51, 52 annular portion, 53 pillar portions, 54 pocket, 55, 56 projecting region, 61 groove, 62 opening, 63, 64 wall surface.

1. A radial thrust bearing that receives a load in a radial direction and a load in a thrust direction, the radial thrust bearing comprising:
a plurality of radial rolling elements that are subjected to the load in the radial direction;
a radial cage that holds the plurality of radial rolling elements;
a plurality of thrust rolling elements that are subjected to the load in the thrust direction;
a thrust cage that holds the plurality of thrust rolling elements;
an outer ring including a first outer ring raceway surface that contacts rolling surfaces of the radial rolling elements; and
an inner ring including a first inner ring raceway surface that contacts the rolling surfaces of the radial rolling elements, wherein
the outer ring includes a second outer ring raceway surface that contacts rolling surfaces of the thrust rolling elements,
the inner ring includes a second inner ring raceway surface that contacts the rolling surfaces of the thrust rolling elements,
the outer ring has a through hole that reaches a raceway region of the plurality of radial rolling elements from outside,
the radial cage includes
a pair of annular portions disposed at an interval in an axial direction, and
a plurality of pillar portions coupled to the pair of annular portions and disposed at an interval in a circumferential direction to form pockets that house the radial rolling elements,
radially outer surfaces of the pillar portions include grooves each extending in the axial direction and recessed radially inward, and
each of the grooves has an opening at least one axial end of a corresponding one of the pillar portions.

2. The radial thrust bearing according to claim 1, wherein a wall surface constituting each of the grooves includes an arc-shaped curve, as seen in the axial direction.

3. The radial thrust bearing according to claim 1, wherein each of the grooves has an opening only at one axial end of a corresponding one of the pillar portions.

4. The radial thrust bearing according to claim 3, wherein a wall surface constituting each of the grooves at another axial end includes a portion of a spherical surface.

5. The radial thrust bearing according to claim 1, wherein each of the pillar portions includes projecting regions projecting toward the pockets, on a radially outer side and a radially inner side of the pair of annular portions.

6. The radial thrust bearing according to claim 1, wherein the through hole comprises a plurality of through holes arranged at intervals in the circumferential direction and having openings at a radially outer surface of the outer ring.

7. The radial thrust bearing according to claim 1, wherein each of the wall surfaces constituting the through holes is oriented straight in a radial direction.

8. The radial thrust bearing according to claim 1, wherein each of the wall surfaces constituting the through holes is tapered such that the wall surface is gradually enlarged toward the radially outer surface.

9. The radial thrust bearing according to claim 1, wherein
the plurality of thrust rolling elements are arranged in double rows at both axial ends of the radial rolling elements in the axial direction, and
the thrust cage comprises a pair of thrust cages that holds the plurality of thrust rolling elements arranged in the double rows.

10. The radial thrust bearing according to claim 2, wherein each of the grooves has an opening only at one axial end of a corresponding one of the pillar portions.

11. The radial thrust bearing according to claim 10, wherein a wall surface constituting each of the grooves at another axial end includes a portion of a spherical surface.

12. The radial thrust bearing according to claim 2, wherein each of the pillar portions includes projecting regions projecting toward the pockets, on a radially outer side and a radially inner side of the pair of annular portions.

13. The radial thrust bearing according to claim 2, wherein the through hole comprises a plurality of through holes arranged at intervals in the circumferential direction and having openings at a radially outer surface of the outer ring.

14. The radial thrust bearing according to claim 2, wherein each of the wall surfaces constituting the through holes is oriented straight in a radial direction.

15. The radial thrust bearing according to claim 2, wherein each of the wall surfaces constituting the through holes is tapered such that the wall surface is gradually enlarged toward the radially outer surface.

16. The radial thrust bearing according to claim 2, wherein
the plurality of thrust rolling elements are arranged in double rows at both axial ends of the radial rolling elements in the axial direction, and
the thrust cage comprises a pair of thrust cages that holds the plurality of thrust rolling elements arranged in the double rows.
